(19) United States
(12) Patent Application Publication
(10) Pub. No.: US 2012/0278616 A1
(43) Pub. Date: Nov. 1, 2012

(54) System and Method for Securely Decrypting Files Wirelessly Transmitted to a Mobile Device

(76) Inventor: Mark Liu Stevens, Laguna Hills, CA (US)

(21) Appl. No.: 13/094,755

(22) Filed: Apr. 26, 2011

(51) Int. Cl. H04L 9/00

(52) U.S. Cl. 713/165

(57) ABSTRACT

A method is provided for securely decrypting files that are wirelessly sent to a mobile device. A mobile device typically has a wireless interface, such as a cellular telephone or WiFi interface that can be used to accept an encrypted file from a first remote device. A decryption key representation is accepted from a second remote device via a personal proximity interface which can be a camera, microphone, or near-field radio frequency (RF) detector. In one aspect, the first device can, for example, be a multi-functional peripheral (MFP), a network server, or a computer. In another aspect, the first and second devices can be the same device, such as an MFP or a computer. A mobile device conversional application converts the decryption key representation to a digital decryption key, and the digital decryption key is then used to decrypt the encrypted file.

### BACKGROUND OF THE INVENTION

1. Field of the Invention

This invention generally relates to secure digital communications and., more particularly, to a system and method for protecting a decryption key being delivered to a wireless communications mobile device.

2. Description of the Related Art

As mobile phones and related mobile devices become more sophisticated, the opportunity arises to provide capabilities like carrying documents and reading them, or distributing them using the mobile phone as the primary storage and display. Unfortunately, many of today's mobile devices do not have the capability to provide secure Internet connections such as a VPN (virtual private network). While a mobile device user may wish to store, read and share, or print a document using his or her cell phone as a secure personal storage device, they may also require that the document be securely delivered so that it is never at risk of being shared or stolen.

The problem becomes one of finding a way to create, deliver, and store a confidential document to a mobile device such that it is never subject to eavesdropping or hijacking while being delivered through a public over-the-air network connection. Ideally, the solution should be available for use in a public or private establishment such as a copy center or corporate multifunctional peripheral (MFP) copy/scanning device, and might be realized using commercial off the shelf software on the target mobile device, in combination with proprietary software run on the MFP, on a remote server providing an application service to the MFP, or a combination thereof.

A conventional approach to the problem is to use an MFP to digitally scan and deliver the document as a Portable Document Format File (PDF) file to a person's email account after entering their email address as the scanning destination. The person would then use their email program to react and save the attached PDF. They would need to set the password at the time of scanning, or they would need to use a PDF editor like Adobe Acrobat to digitally encrypt the attachment after receipt and saving of the email attachment. Because of the difficulty of entering a long secure password on both the MFP and the mobile device, a short insecure password may be used.

The person would then need to physically connect their mobile device to their computer, or tether it through a wireless connection such as Bluetooth, and then copy the encrypted document to the mobile device where they can be assured that it is safe from observation. This scenario is possible in a workplace setting where all the accessories might be provided, but in a public setting like a copy center, it would be more difficult to assure that the cables and drivers are loaded on the public workstation, or that the person's email account is accessible.

In any event, this scenario is time consuming and error prone as the unlucky person must remember and enter several key pieces of information (passwords, email address, attachment locations, and storage device drives) unfamiliar systems and possibly even in public locations where they can easily be Observed or recorded without the person's awareness.

It would be advantageous if encrypted files could be sent to a wireless device over a public network, while the decryption key is transmitted by a more secure interface.

### SUMMARY OF THE INVENTION

Disclosed herein are means to solve the above-mentioned problem by creating a system of services that doesn't rely on a person to enter any key personal information or creatively follow numerous series of steps in order to achieve the result of simply obtaining an important confidential document, without exposing any of that data in the process of delivering it, even in a public setting. The method relies upon the combination of several properties of modern hardware systems, such as the ability to run customized or third party applications on both mobile devices and multi-function peripherals (MFPs), which together form a unique delivery system that provides capabilities and ease of use

In one aspect, the solution relies upon delivering a strongly encrypted document to the mobile device, as well as established 2-D barcode reading methods to deliver a password to the mobile device securely. The combination provides a unique solution to this difficult problem. Application software running within an MFP scans and digitally encrypts a document at the MFP. In addition, the application presents a custom image on the MFP display that allows the application to securely deliver the decryption key to a mobile phone or similar device equipped with a digital camera and the ability to run third party software (such as a Blackberry, iPhone, or Android level device).

Accordingly, a method is provided for securely decrypting files that are wirelessly sent to a mobile device. A mobile device typically has a wireless interface, such as a cellular telephone or WiFi interface that can be used to accept an encrypted file from a first remote device. A decryption key representation is accepted from a second remote device via a personal proximity interface which can be a camera, microphone, or near-field radio frequency (RF) detector. In one aspect, the first device can, for example, be a multi-functional peripheral (MFP)), a network server, or a computer. In another aspect, the first and second devices can be the same device, such as an MFP or a computer.

A mobile device conversional application converts the decryption key representation to a digital decryption key, and the digital decryption key is then used to decrypt the encrypted file. In one aspect, a mobile device camera captures an image representing the decryption key, as provided on a second remote device display screen. For example, the image may be a Quick Response (QR) code image.

A method is also provided for protecting encrypted files wirelessly sent to a mobile device. A first device, such as an MFP, computer, or network server uses a wireless interface, such as a cellular telephone or WiFi, to send an encrypted file to a first mobile device. A second device sends a decryption key representation to the mobile device via a personal proximity interface (display screen, audio speaker, or near-field RF transmitter). As above, the first and second devices may be the same device.

Additional details of the above-described methods, a wireless mobile device with a personal proximity interface, and a system for securely transmitting encrypted files wirelessly sent to a mobile device are provided below.

### BRIEF DESCRIPTION OF THE DRAWINGS

FIG. 1 is a schematic block diagram of a wireless mobile device with a personal proximity interface for protecting encrypted files transmitted via a wireless interface.

FIG. 2 is a schematic block diagram of a variation of the system of FIG. 1, where the first and second remote devices are the same device.

FIG. 3 is a diagram depicting a sequence of events associated with the use of a public document server to store encrypted documents for a mobile device to retrieve at its convenience.

FIG. 4 is a flowchart illustrating a method for securely decrypting files that are wirelessly sent to a mobile device.

FIG. 5 is a flowchart illustrating a method for protecting encrypted files wirelessly sent to a mobile device.

### DETAILED DESCRIPTION

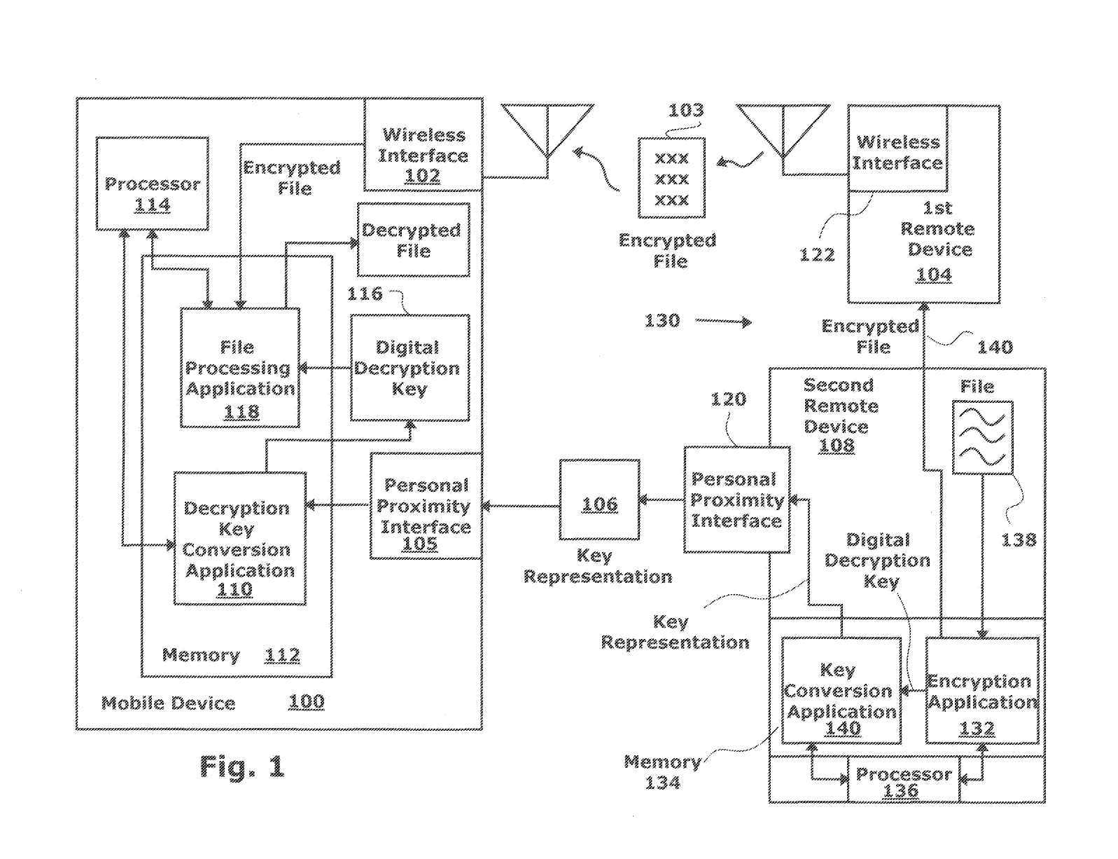

FIG. 1 is a schematic block diagram of a wireless mobile device with a personal proximity interface for protecting encrypted files transmitted via a wireless interface. The mobile device 100 comprises a first wireless interface 102 that may, for example, be a cellular telephone or WiFi (IEEE 802.11) interface, to accept an encrypted file 103 from a first remote device 104. Although not explicitly depicted, device 100 may also use a hardwired interface instead of a wireless one. However, hardwired networks are less susceptible to eavesdropping. A number of document encryption methods are known in the art, any of which would enable the devices described herein. Public key as well as symmetric key algorithms may be used. The mobile device 100 also comprises a personal proximity interface 105 that may, for example, be a camera, microphone, printer, or near-field radio frequency (RF) detector. The personal proximity interface 105 accepts a decryption key representation 106 from a second remote 108. A decryption key conversion application 110, enabled as a sequence of software instructions stored in a local memory 112 and executed by a processor 114, converts the decryption key representation 106 to a digital decryption key 116. A file processing application 118, enabled as a sequence of software instructions stored in the local memory 112 and executed by the processor 114, uses the digital decryption key 116 to decrypt the encrypted file 103.

in one aspect, the personal proximity interface 105 is a camera capturing an image representing the decryption key 106, provided on a second remote device personal proximity interface 120 display screen or printed on a sheet of paper. For example, the decryption key representation may be a Quick Response (QR) code image. A QR code is a specific type of matrix, or two-dimensional barcode that is readable by dedicated QR barcode readers and camera phones. The code consists of black modules arranged in a square pattern on a white background. The information encoded can be text, URL, or other data, such as a key code. Google's mobile Android operating system supports QR codes by natively including the barcode scanner (ZXing) on some models. Nokia's Symbian operating system is also provided with a barcode scanner, which is able to read QR codes, while mbarcode is a QR code reader for the Maemo operating system. In the Apple iOS, a QR code reader is not natively included, but many free applications are available with reader capability. More generally, the personal proximity interface may be configured to read conventional barcode or other types of message formats. In one aspect, the personal proximity interface can read decryption key information displayed as a sequence of decimal, hex, or even binary numbers.

In another aspect, the personal proximity interface 105 is a microphone capturing an audio sequence representing the decryption key 106, provided by a second remote device personal proximity interface 120 speaker. For example, the audio sequence may be formatted as a facsimile transmission. Alternatively, the personal proximity interface 105 may be similar to an RF identification (RFID) tag reader and the second remote device personal proximity interface 120 may be a passive device that only transmits in signal in very close proximity to the reader. Bluetooth is another possible personal proximity interface. However, due to the Bluetooth transmitter power levels, these signals would be more susceptible to eavesdropping. In some aspect, Bluetooth may be used as the first wireless interface 102.

The first remote device 104 may be a multi-functional peripheral (MFP), a network server, or a computer. As used herein, an MFP is a device capable scanning documents, and is also typically capable of functioning as a copier and printer, and typically has a network interface. The encrypted file may be a file that was scanned on an MFP. In one aspect, the file may have been scanned and encrypted on an MFP and the encrypted file sent (via a secure hardwired link) to a server, acting as the first mobile device. In this aspect, the MFP may act as the second remote device. In another aspect, the MFP may scan and encrypt a file, and send it to a computer or wireless access point acting as the first remote device 104. Again, the MFP would be acting as the second remote device 108.

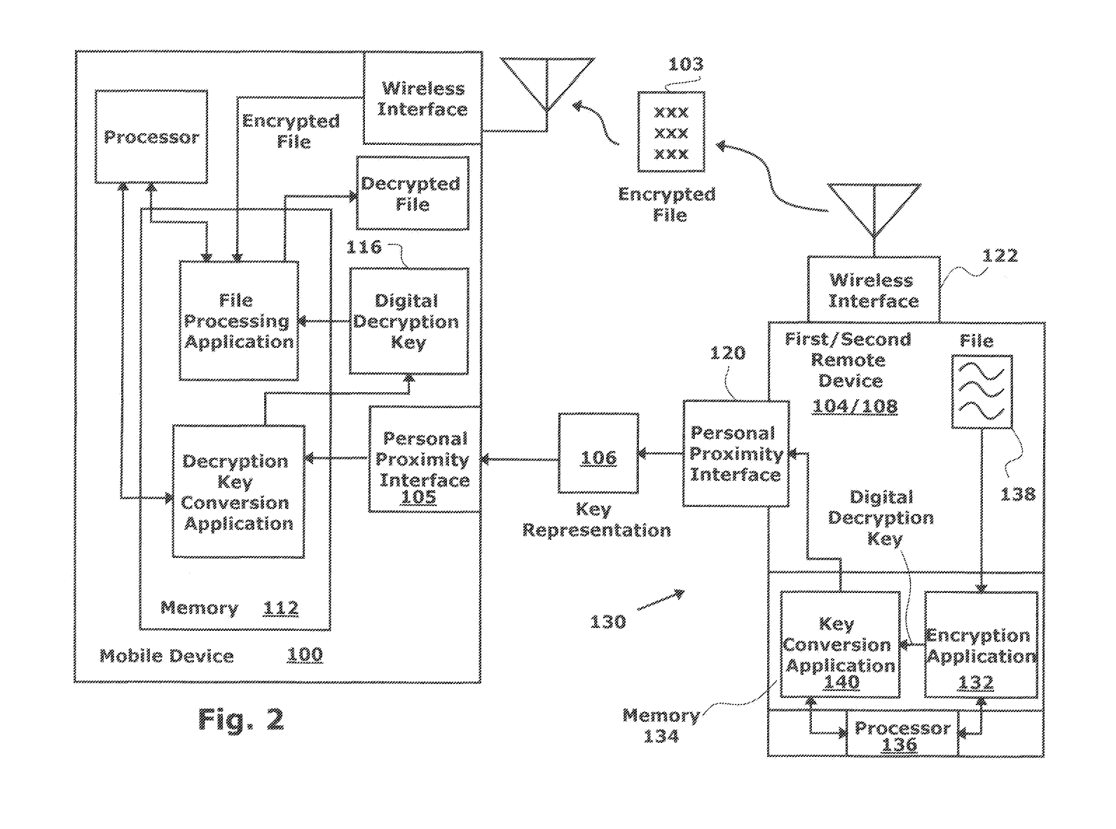

FIG. 2 is a schematic block diagram of a variation of the system of FIG. 1, where the first and second remote devices are the same device. In one aspect, the first/second remote device 104/108 is an MFP. In this scenario, the MFP 104/108 may scan a file, encrypt the file, send the encrypted file via a wireless interface 122, and send the decryption key representation 106 via its personal proximity interface 120. In another aspect, the first/second remote device 104/108 is a computer. The computer 104/108 retrieves a file from storage. If the file is already encrypted, the computer also accesses the decryption key. If the file is not already encrypted, the encryption process is performed and decryption key is generated. The encrypted file is sent via wireless interface 122, and the decryption key representation 106 sent via personal proximity interface 120.

Viewing FIG. 1 from a different perspective, a system is presented for securely transmitting encrypted files wirelessly sent to a mobile device 100. The system 130 comprises the first device 104 having a first wireless interface 122, for example, either a cellular telephone or WiFi interface, to send an encrypted file to the first mobile device 100. A second device 108 has a personal proximity interface 120 to send a decryption key representation 106 to the first mobile device 100, where the personal proximity interface 120 can he a display screen, audio speaker, printed sheet, or a near-field RF transmitter.

In one aspect, an encryption application 132, stored as a sequence of software instructions in a local memory 134 and executed by a processor 136, accepts a file or scan 138, and creates the encrypted file and a digital decryption key. A key conversion application 140, stored as a sequence of software instruction in local memory 134 and executed by processor 136, accepts a digital decryption key associated with the encrypted file, and converts the digital decryption key to the decryption key representation.

In another aspect, the first device 104 is a network server and the second device 108 is a MFP. The MFP 108 scans a document 138, encrypts the scan file, and sends the encrypted file to the sever 104 via a network connection on line 140. More generally, the first device 104 can be an MFP, a network server, a computer, or wireless access point, while the second device is typically either an MFP or computer.

In one aspect, the second device proximity interface 120 is a display screen for presenting an image representing the decryption key, or a printer engine for printing an image representation of the decryption key on a sheet of paper. For example, the decryption key representation may be a QR code image. In another aspect, the second device proximity interface 120 is a speaker broadcasting an audio representation of the decryption key, or a RFID transmitter.

Returning to FIG. 2, in one aspect, the first and second devices may be the same device 104/108. As explained above, this combined device is typically either an MFP or a computer.

### Functional Description

In one aspect, the mobile device user runs an application on the mobile device that contacts a network server to negotiate the document destination. The destination can be either directly to the mobile device itself (FIG. 2) or a storage location on a remote server where the mobile device can retrieve the encrypted document (FIG. 1). The user then initiates a document application on the MFP. The document application begins the scanning of a document followed by encryption, and then delivery to the mobile device directly, or through the intermediate server. The encryption key may be generated randomly by the MFP and it may he long and difficult to communicate (128 random characters or more).

In one aspect, the key is then encoded locally on the MFP as a QR Code image (a form of barcoding used for delivering textual information fields) or similar barcode capable of encoding between 128 and 2048 characters in a barcode image. The MFP displays the barcode image on the MFP front panel as the document is scanned, encrypted, and delivered across the network. As the MFP displays the QR code, the mobile device user uses the camera on the mobile device to scan the barcode image and decode it. The QR code contains the decryption key that can be used to open the document once it's delivered to the mobile device as an encrypted document.

Since the decryption key has never been delivered across a public network, and the document is digitally encrypted by a password that is not known even to the document storage server, the document has been delivered to a mobile device without ever compromising the confidentiality of the document's contents.

As an added benefit to this type of system, the primary user can also use this system to directly deliver a document to a secondary person, or persons, by storing the QR code, and then, either displaying the QR Code on the primary user's device screen, or printing and displaying it in paper form, such that the secondary users can use the same or similar QR code reader software to acquire the decryption key and decrypt the document similar in manner as the primary user.

Because the delivery of the encryption key is not connected to the network transmission, the barcode image can also be saved or printed, and used to decrypt the document later on, with intermediate transmissions possible based upon the circumstance required by the document carrier.

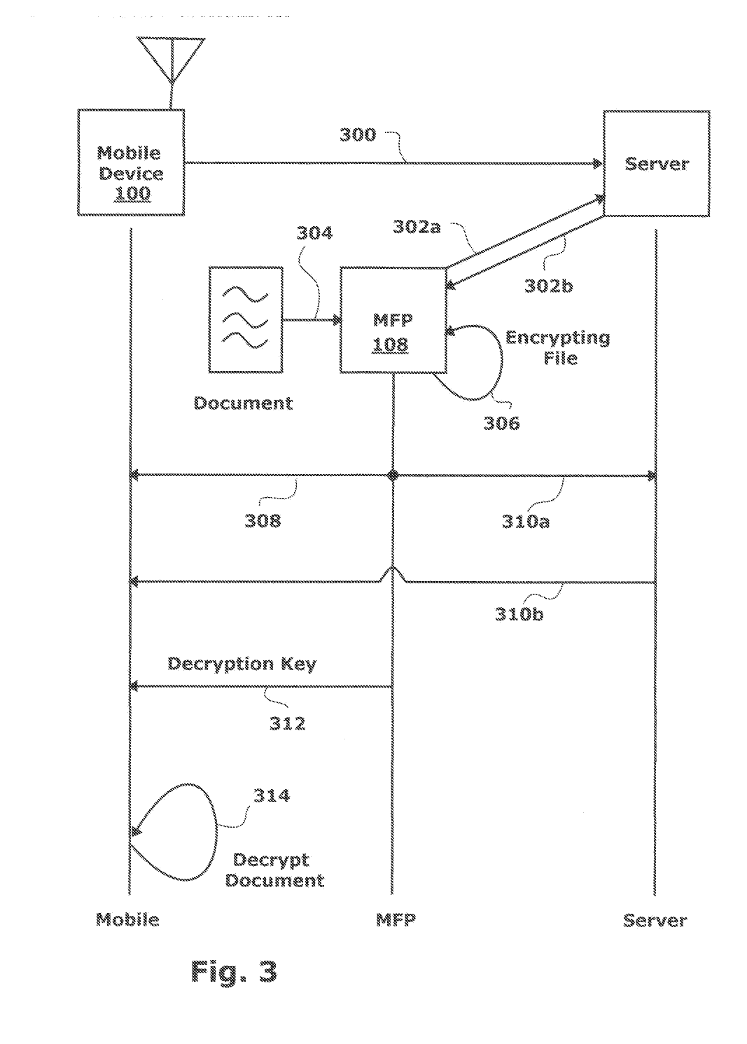

FIG. 3 is a diagram depicting a sequence of events associated with the use of a public document server to store encrypted documents for a mobile device to retrieve at its convenience. The process is secure because the decryption key is never placed on the network at any time. In Step 300 the mobile device sends the HTTP address of the MFP 108, initiating the process. In Steps 302a and 302b the application is started at the MFP and communications are established between the MFP and server. In one aspect, the server delivers an application to the MFP that enables encryption and/or generation of a decryption key representation. In Step 304a document is scanned at the MFP. In Step 306 an encrypted. file is generated by the MFP. In one aspect (Step 308) the encrypted file is sent directly to the mobile device. Alternatively, the encrypted file is sent to the server in Step 310a, which then sends the encrypted file to the mobile device in Step 310b. In Step 312 the MFP sends the decryption key representation to the mobile device, and in Step 314 the mobile device uses the key to decrypt the file.

Thus, the mobile device acquires content independently of the key, relying on time and visual proximity to the key source to acquire the decryption key. Coded data is not embedded into any document. The mobile device must decode using the barcode, for example, eliminating a requirement to transmit key information through a network. However, the encrypted document can be safely transmitted via a wideband public network. The key used to unlock the document is not stored in the document, or used after decryption is completed. In summary, a barcode, or other personal proximity interface, is not used to link, retrieve, or lookup a document via a public network. Rather, the barcode is the secure key transfer mechanism, avoiding the need to transmit any decryption key data across a network.

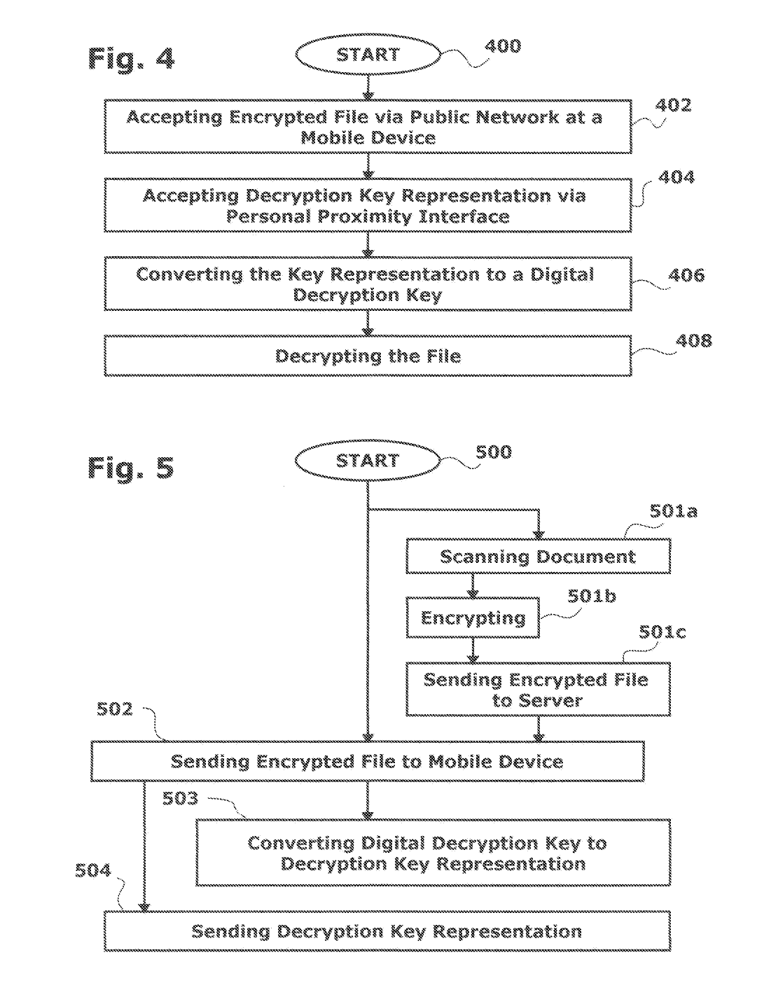

FIG. 4 is a flowchart illustrating a method for securely decrypting files that are wirelessly sent to a mobile device. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 400.

In Step 402 a first mobile device has a first wireless interface, which may be a cellular telephone, WiFi, or other public network interface, accepts an encrypted file from a first remote device. The encrypted file may be accepted from an MFP, a network server, or a computer. In one aspect, the encrypted document accepted in Step 402 was previously scanned on an MFP.

Step 404 accepts a decryption key representation from a second remote device via a personal proximity interface. Some examples of a personal proximity interface include a camera, a microphone, a near-field radio RF detector, or in some circumstances a Bluetooth transceiver. In another aspect, a first mobile device camera captures an image (e.g., a QR code) representing the decryption key, as provided on a second remote device display screen.

In Step 406 a first mobile device conversion application, embedded in a first mobile device memory as a sequence of software instructions stored in a local memory and executed by a processor, converts the decryption key representation to a digital decryption key. Step 408 uses the digital decryption key to decrypt the encrypted file.

FIG. 5 is a flowchart illustrating a method for protecting encrypted files wirelessly sent to a mobile device. The method begins at Step 500. in Step 502a first device having a first wireless interface, such as a cellular telephone or WiFi interface, sends an encrypted file to a first mobile device. In Step 504 a second device sends a decryption key representation to the first mobile device via a personal proximity interface, which may be a display screen, audio speaker, printed sheet, or a near-field RF transmitter. In one aspect, the second device of Step 504 includes a display for presenting an image (e.g., a QR code) representing the decryption key. In one aspect, in Step 503 a second device key conversion application, stored in a local memory as a sequence of software instructions executed by a processor, converts a digital decryption key associated with the encryption file to the decryption key representation.

In one aspect, the first and second devices are the same device. Generally, the first device of Step 502 is an MFP, a network server, or a computer, and the second device of Step 504 is an MFP or computer. In another aspect, in Step 501a an MFP scans a document. In Step 501b the MFP encrypts a scan file. In Step 501c the MFP sends the encrypted file to a sever via a network connection. Then, sending the encrypted file in Step 502 includes sending the encrypted file from the network server.

A system and method have been provided for securely transmitting encrypted files through a public network. Examples of particular message structures and process flows have been presented to illustrate the invention. However, the invention is not limited to merely these examples. Other variations and embodiments of the invention will occur to those skilled in the art.

We claim:

1. A method for securely decrypting files that are wirelessly sent to a mobile device, the method comprising:
a first mobile device having a first wireless interface selected from a group consisting of a cellular telephone and WiFi interface, to accept an encrypted file from a first remote device; and,
accepting a decryption key representation from a second remote device via a personal proximity interface selected from a group consisting of a camera, a microphone, and a near-field radio frequency (RF) detector.

2. The method of claim 1 wherein accepting the encrypted file includes accepting the encrypted file from the first remote device selected from a group consisting of a multi-functional peripheral (MFP), a network server, and a computer.

3. The method of claim 1 wherein accepting the encrypted file includes accepting an encrypted document scanned on an MFP.

4. The method of claim 1 further comprising:
a first mobile device conversion application, embedded in a first mobile device local memory as a sequence of software instructions executable by a processor, converting the decryption key representation to a digital decryption key; and,
using the digital decryption key to decrypt the encrypted file.

5. The method of claim 1 wherein accepting the decryption key representation includes a first mobile device camera capturing an image representing the decryption key, as provided on a second remote device display screen.

6. The method of claim 5 wherein capturing the image includes capturing a Quick Response (QR) code image.

7. A method for protecting encrypted files wirelessly sent to a mobile device, the method comprising:
a first device having a first wireless interface selected from a group consisting of a cellular telephone and WiFi interface, sending an encrypted file to a first mobile device; and,
a second device sending a decryption key representation to the first mobile device via a personal proximity interface selected from a group consisting of a display screen, audio speaker, printed sheet, and a near-field radio frequency (RF) transmitter.

8. The method of claim 7 wherein the first and second devices are the same device.

9. The method of claim 7 further comprising:
a multi-functional peripheral (MFP) scanning a document;
the MFP encrypting a scan file;
the MFP sending the encrypted file to a sever via a network connection; and,
wherein sending the encrypted file includes sending the encrypted file from the network server.

10. The method of claim 7 wherein sending the encrypted file includes sending the encrypted file from a first device selected from a group consisting of an MFP, a network server, and a computer; and,
wherein sending the decryption key representation includes sending the decryption key representation by a second device selected from a group consisting of the MFP and the computer.

11. The method of claim 7 wherein sending the decryption key representation includes a second device display presenting an image representing the decryption key.

12. The method of claim 11 wherein presenting the image includes the second device presenting the decryption key as a Quick Response (QR) code image.

13. The method of claim 7 further comprising:
a second device key conversion application, stored in a local memory as a sequence of software instructions executed by a processor, converting a digital decryption key associated with the encryption file to the decryption key representation.

14. A wireless mobile device with a personal proximity interface for protecting encrypted files transmitted via a wireless interface, the device comprising:
a first wireless interface selected from a group consisting of a cellular telephone and WiFi interface, to accept an encrypted file from a first remote device;
a personal proximity interface selected from a group consisting of a camera, a microphone, and a near-field radio frequency (RF) detector, accepting a decryption key representation from a second remote; and,
a decryption key conversion application, enabled as a sequence of software instructions stored in a local memory and executed by a processor, converting the decryption key representation to a digital decryption key.

15. The device of claim 14 wherein the first wireless interface accepts the encrypted file from the first remote device selected from a group consisting of a multi-functional peripheral (MFP), a network server, and a computer.

16. The device of claim 14 further comprising:
a file processing application, enabled as a sequence of software instructions stored in the local memory and executed by the processor, using the digital decryption key to decrypt the encrypted file.

17. The device of claim 14 wherein the personal proximity interface is a camera capturing an image representing the decryption key, provided on a second remote device display screen.

18. The device of claim 17 wherein the personal proximity interface captures a Quick Response (QR) code image.

19. The device of claim 14 wherein the personal proximity interface is a microphone capturing an audio sequence representing the decryption key, provided by a second remote device speaker.

20. A system for securely transmitting encrypted files wirelessly sent to a mobile device, the system comprising:
a first device having a first wireless interface selected from a group consisting of a cellular telephone and WiFi interface, to send an encrypted file to a first mobile device; and,
a second device having a personal proximity interface to send a decryption key representation to the first mobile device, where the personal proximity interface is selected from a group consisting of a display screen, audio speaker, printed sheet, and a near-field radio frequency (RF) transmitter.

21. The system of claim 20 wherein the first and second devices are the same device.

22. The system of claim 20 wherein the first device is a network server; and,
wherein the second device is a multi-functional peripheral (MFP), the MFP scanning a document, encrypting the scan file, and sending the encrypted file to the sever via a network connection.

23. The system of claim 20 wherein the first device is selected from a group consisting of an MFP, a network server, and a computer; and,
wherein the second device is selected from a group consisting of the MFP and the computer.

24. The system of claim 20 wherein the second device proximity interface is a display screen for presenting an image representing the decryption key.

25. The system of claim 24 wherein the second device presents the decryption key as a Quick Response (QR) code image.

26. The system of claim 20 wherein the second device proximity interface is a speaker broadcasting an audio representation of the decryption key.

27. The system of claim 20 further comprising:
a key conversion application in the second device, stored as a sequence of software instructions in a local memory and executed by a processor, for accepting a digital decryption key associated with the encrypted file, and converting the digital decryption key to the decryption key representation.
